(19) United States
(12) Patent Application Publication
(10) Pub. No.: US 2018/0127100 A1
(43) Pub. Date: May 10, 2018

(54) Lining Panel And Method For Manufacturing Lining Panel

(71) Applicant: Airbus Operations GmbH, Hamburg (DE)

(72) Inventor: Ingo Roth, Hamburg (DE)

(73) Assignee: Airbus Operations GmbH, Hamburg (DE)

(21) Appl. No.: 15/805,315

(22) Filed: Nov. 7, 2017

(30) Foreign Application Priority Data
Nov. 8, 2016 (DE) 10 2016 121 366.7

(51) Int. Cl. B64D 13/04; B64C 1/18

(52) U.S. Cl. CPC B64D 13/04; B64C 2001/009; B64C 1/18

(57) ABSTRACT

A lining panel having a panel element, a rectangular through hole and a flap is provided. The lining panel has a flap which is rotatable about a hinge integrated into the panel element in order to open and/or close the rectangular through hole. A fuselage element for an aircraft includes such a lining panel.

### FIELD OF THE INVENTION

The present invention relates to the technical field of aerospace engineering. In particular, the present invention relates to a lining panel and to a method for manufacturing a lining panel.

### BACKGROUND OF THE INVENTION

Aircrafts are pressurized in order to compensate pressure differences during all level of flight and to generate a comfortable and safe environment for passengers inside a pressurized cabin. When pressurized airplane flying at a high altitude, the pressure outside the airplane is considerable lower than inside. As a result of pressurizing the airplane a pressure difference may even occur inside the aircraft between different compartments of the airplane such as a passenger compartment and a cargo compartment.

In the event of any damage the pressure between different areas of the cabin can reach a limit so that uncontrolled decompression can appear by damaging any separating barrier that cannot sustain the pressure difference. For allowing a controlled equalization of pressure differences between for example a cargo compartment and a passenger compartment a rapid decompression function can be integrated into a barrier element. Such barrier element may be a lining panel, a cabin lining or a dado-panel used for building a sidewall of a passenger cabin. For controlling a pressure equalisation so called rapid decompression doors are installed in some lining panels. However, these decompression doors comprise several parts leading to acoustical gaps within the rapid decompression doors after being assembled. As a result of using several parts for building a cabin lining element having a rapid decompression door interferences of noise may arise during the flight.

Document U.S. Pat. No. 4,432,514 relates to a decompression equalization relief valve.

Document U.S. Pat. No. 6,264,141 describes an aircraft decompression protection panel.

### BRIEF SUMMARY OF THE INVENTION

It may be seen as a need to provide a more efficient rapid decompression function. According to an aspect of the invention, a lining panel and a method for manufacturing a lining panel is provided.

Even if the invention is described with regard to an aircraft or airplane, the subject matter of the invention can be used in all types of means of transport such as airplanes, trains, cars and/or boats.

According to an aspect of the present invention, a lining panel is provided, the panel comprising a panel element having a front side and a back side. The panel element has a rectangular through hole and a flap. The flap is movable about a hinge in order to open and/or close the rectangular through hole. The hinge is integrated into the panel element. In an example the flap fits into the through hole.

Integrating a hinge into the panel element, for example by manufacturing the hinge from the same basis material as the panel element, may reduce the number of parts which are necessary to build a panel element. In particular, the number of parts are reduced, which are used for building the rapid decompression function into such a panel. Generating the lining panel and the flap so that the hinge is an integral part of the lining panel and the flap, and manufacturing the lining panel and flap as a single part may reduce the weight and the costs for providing such a lining panel. Also gaps can be minimized such that the audible sound generated by such a monolithic rapid decompression door is reduced. Manufacturing the rapid decompression door as one single monolithic piece with the panel element may allow to close the door with a predetermined pressure. This pressure may be directed against a frame of the rectangular through hole and be directed away from the hinge. Such a pre-set pressure for closing the door may be used to set up a limit for the pressure or force that can be sustained by the closed door. If this limit is exceeded the door can open in the direction of the pressure difference, i.e. in the direction of the gradients of the pressure field. In an example the monolithic structure may be generated by extruding and/or expanding polymer particles.

In another example the flap may be made as a single part. In yet another example the flap comprises a plurality of flaps. Structuring the flaps as at least two flaps and/or as sub-groups of flaps may help to adjust the force that is required to open the relevant flap. If a plurality of flaps is used the functionality of letting overpressure pass may be maintained even if a sub-group of the flaps is blocked.

In yet another example the through-hole may be cut into the panel at two and/or three continuous lines forming a frame. In this way a flap is formed by the cut away material. One end of the flap is heated and pressed in order to form a film hinge. This film hinge allows for the flap to be moved in substantially any directing about the hinge. The lining panel may be manufactured in one shot by an extrusion process and/or molding process. The material for the lining element is put into a die and/or into a molding form and by addition of heat in form of hot air the lining panel is formed. As an option, additional elements may be added into the die and/or into the molding form in order to integrate them into the lining panel. In a further example the additional elements may be reinforcement elements, reinforcement profiles or reinforcement parts that are integrated into the lining panel. Also a reinforcement layer or a coating layer, support elements and/or a U-profile may be used as additional parts. By way of hot extrusion and/or foam molding, the lining panel is formed as an element substantially made of foam. The lining panel as product of extrusion is generally called “extrudat” and has the structure of a foam, in particular an expanded polystyrene (EPS). In other words, in the foaming process solid plastic is expanded into a foam through the use of heat, usually steam. In an example the lining panel is made of particle foam, a sub-class of closed cell foams or syntactic foams. In an example the lining panel may be manufactured by a foam molding process.

According to another aspect of the present invention, a method for manufacturing a lining panel is provided. Manufacturing of the lining panel comprises providing a panel element having a front side and a back side and manufacturing a rectangular through hole and a flap into the panel element. The rectangular through hole and/or the flap is/are manufactured into the panel element in such a way that the flap is movable or turnable about a hinge integrated into the panel element in order to open and/or close the rectangular through hole. Instead of generating a frame by cutting the frame a part of the frame of the through hole is at least partially formed by a rib of a salient element. In an example the flap is arranged on a salient forming a duct.

The hinge may be generated by pressing a part of the panel element in order to build a thin foil which flexibly links the flap with the panel element and/or with the salient or salient element. This compression of a part of the material of the panel element and/or of a salient element is forming a turnable connection between the flap and the panel element and the salient, respectively without dividing the panel element and the flap. This connection or film hinge is monolithically integrated into the panel element and is flexible enough to allow opening and closing of the through hole. The hinge may be formed after a foaming process. The limit for a force that is necessary to open the flap may be adjustable. By cutting a flap into the panel element the lining panel, the panel element and/or the salient element may be produced from a single part, e.g. a previously generated extrudat.

The panel element for the dado-panel may be made in one shot including the flap for the rapid decompression door for a rapid decompression function. Further parts such as reinforcement layers or reinforcement profile may be integrated during the one shot molding process by positioning them at the target positions. The lining panel may be formed as a modular element in order to be able to form a wall by assembling a plurality of lining panels. In one example the hinge may be formed after the lining panel has been removed from the form molding system. A dado-panel made in one shot may prevent assembling a plurality of individual separate parts. The film hinge may prevent assembling individual parts such as injection molding parts, spring elements and/or hinge shafts. Specifically, this rapid decompression door made as a single part may also prevent using a plurality of individual components which have a certain tolerance to be movable in case of a rapid decompression. If it is prevented to assemble a plurality of elements, gaps between single elements may be prevented too. Audible sound generated by such gaps during a flight may also be prevented, when the panel element is substantially made monolithically or from one piece.

In order to allow for interlocking and safe closing of the through hole in a normal operating mode, the flap may be pressed against a side inside of the through hole. The pressure may be generated by using the elasticity of the film hinge. In other words, the foil hinge or film hinge may be generated in such a way that it generates a pressure against a frame and/or an inside wall of the through hole. This pressure may generate friction that can control the force that is required to open the flap. This friction may be strong enough to keep the flap in a fixed position under normal pressure. For example, in a normal scenario the panel element and the flap can form a duct or a channel for transporting compressed air. Compressed air may be used for air conditioning of a cabin. The compressed air may be transported by a channel or duct formed by the flap on the backside of a panel element. A bottleneck may be generated inside the duct in order to maintain a certain predefined pressure of the air circulation.

In a closed scenario under normal pressure the closed flap may form a wall of the duct. Normal pressure that may be sustained by such a duct with a closed flap under normal conditions may range between 10 hPa and 30 hPa. In other words, the flap may stay in a closed position as long as the pressure exercised to it is below 30 hPa. The maximum pressure that can be sustained by the closed flap forms a pressure limit the rapid decompression door is made for. This pressure limit may be adjusted by varying the thickness of the flaps, the number of sub-flaps and/or the pressure exerted on a side of the through hole. In an example the wall thickness of the flap is equal to the wall thickness of the panel element. In another example the wall thickness of the flap is different from the wall thickness of the panel element. For example, the wall thickness of the flap is thinner or thicker than the wall thickness of the panel element. In case of an overpressure the flap may open the rectangular through hole and let the pressure pass in the direction of the pressure difference. The film hinge is constructed such that any direction for pivoting the flap around the hinge is possible. The film hinge may have a thickness of 1 mm, a thickness in the range of 0 mm and 2 mm or a thickness below 1.5 mm. The pressure limit from which on the flap may have to open automatically can be dimensioned as to be equal to or higher than 30 hPa. It might be a requirement of a statutory policy and/or an operator policy to open the flap within 30 milliseconds after the pressure limit is exceeded.

According to a further aspect of the invention, the lining panel further comprises a salient, wherein the salient is arranged on the back side of the panel element and the salient comprises a flap.

The salient, the projecting element, the flange or the elevating member may help to generate a duct, a channel or a double wall. The salient may be formed monolithically from the panel element. The duct may be supported by a U-profile or a U-shaped profile in order to maintain a cross section even if a high pressurized air flows through that duct. Such a duct built by a salient under normal conditions may be used to guide air in a predefined direction behind the panel element. In order to balance the pressure under normal conditions the duct may comprise a bottleneck formed by a bottleneck structure integrated into the duct. In an example, in an installed state such a duct may be arranged between the panel element and an outer skin of the aircraft. In a normal operation mode, such a duct may be used for air-conditioning air. In particular the bottleneck structure may support maintaining a constant pressure for an air-condition flow. The salient or salient element elevates the plane in which the flap and/or flaps is/are installed and separates the flap plane from the panel element or from a reinforcement profile added to the panel element. The salient element may space the flaps from the plane of the panel element and may result in the flaps in a closed position being substantially parallel to the panel element. In this closed state the basis and/or a foot area of the lining panel is directed to a cabin floor and/or to a floor angle. The basis may comprise an opening with a predefined cross section. The cross section may taper in the direction from the basis of the lining element to the area above the hinge of the flap. The salient may allow for using a reinforcement profile in order to cover the duct generated by the salient. The salient may also prevent opening of the flaps by external force executed by passengers unintentionally contacting the lining panel. In the basis area a rib may be enforced by a U-profile.

According to another aspect of the present invention, the hinge is formed from the material of a border or frame of the through hole.

In other words, the flap and the hinge joint are generated by flattening, pressing or compressing a part of the border of the through hole. The flap is formed by narrow down a portion of the material of the panel element. The hinge may be formed as to be parallel to one side of the through hole. In an example the hinge is a film hinge oriented parallel to the longer side of the through hole. In yet other words, the flap is generated by flattening a part of the panel element and in this way generating a flexible part of the panel element. For flattening a high temperature may be used. In still other words, when cutting the through hole into the panel element there may be a residue or rest portion that still be linked to the panel element. This rest portion may form part of a frame or border of the through hole. This rest portion may be flattened and transformed into a film hinge.

The panel element and/or the salient element are made from foam. The foam may be EPS (Expanded Polystyrene) foam or EPP (Expanded Polypropylene) foam. The foam may fulfil requirements with regards to fire, smoke and/or toxicity provided by a policy, in particular by a policy relevant to airplanes. The elements and/or parts of the elements of the lining panel may be made from a particle foam.

According to another aspect of the present invention, the lining panel has a flap which in combination with the through hole forms a tongue-and-groove joint.

The flap has an edge opposite to the hinge where a groove is formed. Also the frame of the through hole has an edge facing the hinge. This edge of the border of the through hole opposite to the hinge is formed as a tongue. In a closed position the groove and the tongue can engage to form a tongue-and-groove joint. This tongue-and-groove joint can help to dimension the pressure that can be sustained from the flap without opening. In order to close the through hole or the break through, it may be necessary to bend the flap and to engage the tongue and groove. Bending the flap may generates an additional force into the direction of the tongue-and-groove joint. This pressure in combination with the thickness of the flap can be used to dimension a predefined pressure that can be sustained from the flap in a closed position, for example below 30 hPa. In this way, an artificial breaking point or a predetermined braking point can be realised which in case of overpressure can allow to equalize the pressure difference within short time. If the pressure situation returns to a normal state, the flap can be brought back in the closed position and the lining element can be reused.

According to another aspect of the present invention, the lining panel comprises the reinforcement layer on the front side. The reinforcement layer can cover any foam part such as panel element, ribs, flaps and/or the salient element.

The front side may be the side of the panel which faces in an installed mode of the lining element the inside of a passenger cabin of a means of transportation. This side facing the area where passengers are moving around is endangered to be contacted by a passenger. In order to provide a robust surface at least a part of the panel element is covered by a thin layer. The thin layer, the protection cover or the protection layer may be made of a non-reinforced thermoplastic polymer. The protection layer together with the panel element may form a sandwich structure of different sized layers and of different materials The thin layer may have a thickness of equal or below 0.5 mm. The protection layer may be built on the panel element when the panel element itself is built. The protection layer may also prevent opening of the flaps by external force executed by passengers unintentionally contacting the lining panel.

In addition to the non-reinforced thermoplastic layer in order to provide for further protection, a part of the panel element may be made of a reinforced profile. Such an element may be made from a material other than the panel element and/or the salient. This reinforcement profile may help to maintain the diameter or cross-section of a duct of an airflow and/or may protect a duct from external force. The cross-section may be maintained by a combination of the reinforcement profile, a U-profile and a floor angle. The reinforcement profile provided on the front side can provide additional robustness to prevent deformation of the surface of the panel element by touching the surface. The reinforcement profile may replace a portion of the panel element and may also be covered by the thin protection layer. The reinforcement profile may be integrated into the panel element at the same time when the panel element itself is built. In an example, the reinforcement profile has the same thickness as the panel element, e.g. 10 mm. In another example the reinforcement profile is thicker than the panel element. In yet another example the panel element and the reinforcement profile may form a sandwich. The reinforced profile may also prevent opening of the flaps by external force executed by passengers unintentionally contacting the lining panel.

According to another aspect of the invention, the panel element comprises ribs for supporting the salient. The ribs are installed on the back side of the panel and can be used to mount the protruding part of the panel element. The ribs can also help to generate a duct between the front side of the panel element and the through hole.

In addition, the ribs can prevent bending of the panel and stabilize the shape of the lining panel. The ribs are approximately kidney-shaped, piano shaped, bottle-shaped or triangular and taper in one direction. They have a smaller end extending into the direction of the salient. The shape of the ribs corresponds in the area of the salient to the cross-section of the salient. In other words, the salient can be assumed to be as a cylinder formed by moving a part of the ribs along a linear axis parallel to the panel element. The ribs may substantially be arranged perpendicular to the panel element, to the reinforcement profile, to the through hole and/or to the flaps. In order to form a duct for the air the salient has a hollow interior. This hollow interior is supported by the ribs. The borders of the hollow interior substantially are the salient, the flaps, the ribs and optionally an extruded thermoplastic part substantially following the form of the salient. In an example, the ribs have a U-profile integrated into a foot area in order to stabilize the ribs. The U-profile may be used to transfer a force from the panel element and/or from the reinforcement profile to a floor angle. The U-profile may enforce or strengthen the stability under pressure of a rib which is made from a light material. In this way the duct may be maintained even under high pressure. The U-profile may be built into the panel element and/or into the ribs at the time when the panel element itself is built. The U-profile may comprise a longitudinal axis extending parallel to the length of the rib.

According to another aspect of the present invention, the lining panel comprises a floor angle. The floor angle can be used to mount the panel element to the floor, for example to the floor of a passenger cabin and allows installing the panel element in a predetermined distance on the floor of the cabin.

In this way, the panel element can maintain a gap between a lower border of the salient and the cabin floor even in case of rapid decompression. The gap may need to be maintained in order to exchange the air necessary to balance the pressure difference between compartments separated by the panel element. If by pressure the lower edge of the duct may be pressed to the cabin floor and/or into the direction of the flaps the diameter available for an air flow could be reduced and the equalization of the pressure difference may be slow. If the lining panel separates the passenger cabin and the cargo compartment the distance between the salient and the cabin floor is part of the duct for the balancing air flow. In an example the floor angle is mounted to that side of the salient where the flaps are mounted. The through hole and the floor angle is separated by the frame of the through hole. In another example the floor angle is a metal sheet that extends parallel to the panel element. The floor angle can be manufactured from any thin and robust material. The ribs can comprise a U-profile in order to maintain the opening of the duct in case of high pressure. The U-profile may link the foot angle and a reinforcement panel. The U-profile may extend perpendicular to the floor angle and/or to the reinforcement profile. The foot area of the panel element may comprise a groove into which the floor angle can be engaged to allow for easy mounting of the panel element.

According to another aspect of the present invention, a fuselage element comprising the lining panel is provided.

The fuselage element can be an interior lining element which has a predefined size. The size may be dependent from a certain airplane type. The fuselages of different airplane types may have different dimensions. Mounting elements of the fuselage such as stringers or ribs have a well-defined grid and fuselage elements may correspond to this grid in order to increase the mounting speed. The fuselage element may be built as a module in order to allow for a modularized building of an interior lining of a cabin. The module may have a standardized size in order to allow for easy manufacturing and/or mounting.

According to another aspect of the present invention, an airplane is provided comprising at least one of the lining element and the fuselage element.

It has to be noted that aspects of the invention have been described with reference to different subject-matters. Some aspects have been described with reference to apparatus type claims whereas other aspects have been described with reference to method type claims. However, a person skilled in the art will gather from the above as well as the following description, that in addition to any combination between features belonging to one type of subject-matter also any combination between features relating to different types of subject-matter is considered to be disclosed in this text. In particular combinations between features relating to apparatus type claims and features relating to method type claims are considered to be disclosed.

These and other aspects of the present invention will become apparent from and elucidated with reference to embodiments described herein after. Exemplary embodiments of the present invention will be described in the following with reference to the embodiments described hereinafter.

### BRIEF DESCRIPTION OF THE DRAWINGS

FIG. 1 shows a perspective view of a lining panel according to an exemplary embodiment of the present invention.

FIG. 2 shows a detailed view of the flaps of a lining panel according to an exemplary embodiment of the present invention.

FIG. 3 shows a view of the flaps of a lining panel from another perspective than in FIG. 2 according to an exemplary embodiment of the present invention.

FIG. 4 shows a flow chart of a method for manufacturing a lining panel according to an exemplary embodiment of the present invention.

FIG. 5 shows an airplane with a lining panel according to an exemplary embodiment of the present invention.

FIG. 6 shows a perspective view of a passenger cabin having lining panels according to an exemplary embodiment of the present invention.

FIG. 7 shows a partial cross sectional view of a lining panel in a normal operation mode according to an exemplary embodiment of the present invention.

FIG. 8 shows a partial cross sectional view of a lining panel in a first rapid decompression operation mode according to an exemplary embodiment of the present invention.

FIG. 9 shows a partial cross sectional view of a lining panel in a second rapid decompression operation mode according to an exemplary embodiment of the present invention.

FIG. 10 shows a cross sectional view of a rib comprising a U-profile according to an exemplary embodiment of the present invention.

### DETAILED DESCRIPTION

The illustration in the drawing is schematic and may not to scale. In different drawings similar or identical elements are marked with the same reference numerals.

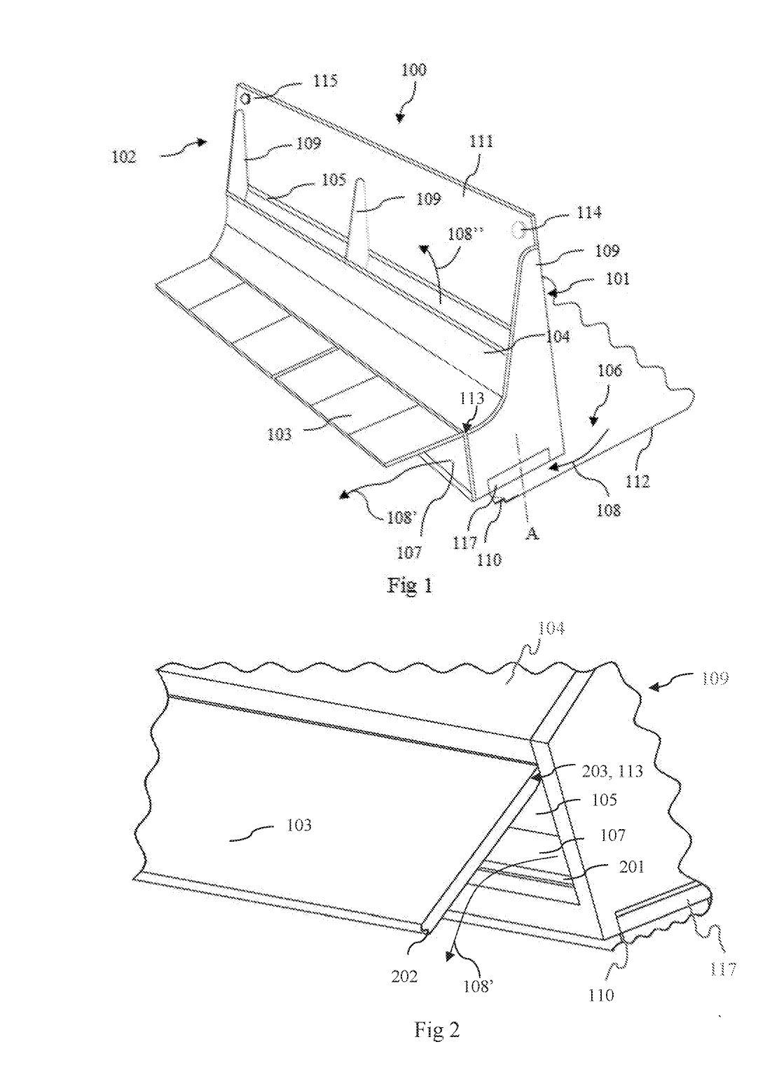

FIG. 1 shows the fuselage element 100 or lining panel 100 according to an exemplary embodiment of the present invention. The lining panel 100 comprises panel element 111 having a front side 101 and a back side 102. The terms “front side” 101 and “back side” 102 may be primarily seen as names in order to differentiate two sides of the panel element 111 but are not intended to be used as a restriction. The front side usually is a name for a side facing an interior area of a cabin. In this interior area, usually passengers are situated or located. The back side 102 of the panel is a name for a side which faces an outside of the fuselage. On the back side, infrastructure of the means of transport can be located. For example, tubes and isolation material are mounted on the back side of the lining panel 100. The backside is located between the panel element 111 and a skin (not shown in FIG. 1) of the means of transportation, for example the skin of an aircraft.

FIG. 1 also shows salient 104 that is located on the backside 102 of lining panel 100. In particular, the salient 104 is formed by three ribs 109 in combination with the salient part 104. The salient part 104 or the salient panel 104 connects the flaps 103 to the panel element 101. The salient 104 is used in order to form a duct with a tapering cross-section in a direction facing away from floor angle 110 and/or floor 112. The dado-panel 100 or lining panel 100 is made from foam in one shot including the rapid decompression door 106 or the rapid decompression function 106. The salient element 104 is attached to the ribs 109 and to the reinforcement profile 105. In another example the salient element 104 is connected to the panel element 111. The reinforcement profile 105 is used to stabilize the front of lining panel 100 and to maintain a gap 106 between the reinforcement profile 105 and the floor angle 110. This gap 106 in combination with through hole 107, break through 107 or hole 107 forms the rapid decompression door 106. In a closed position of the flaps 103, the plane of the flaps lies in a plane parallel to the plane of panel element 111 and/or the plane of reinforcement profile 105. In this closed position (not shown in FIG. 1) flaps 103 substantially cover the through hole 107. The duct that is built by gap 106 between closed flaps 103 and reinforcement profile 105 can be used for transport of pressurized air 108″, for example for transport of air of the air-conditioning system. Ribs 109 are used as distance elements and/or as stabilizing elements for separating flaps 103 from panel element 111 and/or from reinforcement profile 105.

The ribs 109 in FIG. 1 are realized as three extruded thermoplastic parts and help to form the salient 104 and to shift the through hole 107 in combination with the flap 103 into an inner plane lying parallel to the plane formed by the lining panel 111 and/or by the reinforcement profile 105. In this way the salient 104, the ribs and/or the flaps 103 form a duct for supporting an air-flow 108, 108″. On the front side 101, reinforcement profile 105 and panel element 111 lie in the same plane. In FIG. 1 flaps 103 are shown in an open position, open mode or open state. By shifting the flaps 103 into a plane parallel to the plane defined by panel element 111, the ribs 109 form the rapid decompression door 106 comprising the floor angle 110, the lower part of rib elements 109, the reinforcement profile 105, the salient element 104 and the through hole 107. In a closed position (not shown in FIG. 1), flaps 103 cover the through hole 107.

One of ribs 109 is shown in side view. The rib is not covered by a protection layer and therefore, this side view allows to see partly the internal structure of one of the ribs 109. In case a protection layer or protecting layer is used the rib 109 may be covered by the thin protecting layer. In the foot area of the rib 109 a U-profile 117 is integrated into the rib 109. The U-profile is mounted as a bracket 117 around a part of the plane of the rib 109. The thickness of the rib 109 may be in an example 10 mm. In the area of bracket 117, the thickness of rib 109 may be reduced by 1 mm so as to form in combination with U-profile 117 a continuous surface on the sides of rib 109 and/or on the lower edge. A cut through view of rib 109 along line A is shown in FIG. 10.

Flaps 103 are movable around the film hinge 113 in the direction of the back side 102 as well as in the direction of the front side 101. The film hinge 113 is formed by thermoplastic pressing the foam element 104. In other words, element 104, through hole 107 and flaps 103 are manufactured from a foam part by cutting the flap elements 103 and forming the hinge 113 by compressing a part of the salient element 104 and/or of the panel element 111. Thus, the elements 104, 103, 107, 113 are formed from one single monolithic foam element.

To provide sufficient robustness, a thin layer for protection is placed on the front side 101 (not shown in FIG. 1). This thin layer made of a non-reinforced thermoplastic polymer covers the front side of panel element 111 and/or of reinforcement profile 105. The protecting layer may have a thickness of equal to or less than 0.5 mm (millimetres). In another example the thin layer covers at least one side of all elements of the lining panel 100, such as flaps 103, ribs 109, reinforcement profile 105 and/or panel element 111. This thin layer helps to protect the foam element 111 or the panel element 111 against damage that may be caused by passengers who unintentionally hit the lining panel 100.

For protection purposes the rapid decompression door 106 can have a reinforcement profile 105. This reinforcement profile can replace a part of the panel element 111 which is made of foam. In another example the reinforcement profile 105 is used as panel element 111. In yet another example reinforcement profile 105 can be added to panel element 111 as an additional layer. The reinforcement profile 105 helps to maintain a duct of the rapid decompression door. The duct is located between the reinforcement profile 105 and/or the panel element 111, the ribs 109 and the through hole 107. If overpressure appears, an airflow 108, 108′ can flow through rapid compression door 106 and through hole 107 after flaps 103 have been brought into the open position. This airflow 108, 108′ can equalise a pressure difference between front side 101 and back side 102 of the lining panel 100. The airflow is indicated by arrow 108, 108′. The airflow direction under normal condition is indicated as 108″ and passes substantially through the tapered part of the duct between ribs 109, reinforcement profile 105 and flaps 103. The airflow exit under rapid decompression condition is indicated as 108′ and passes substantially through the through hole 107. In other words, under normal conditions the exit for the airflow 108″ is substantially parallel to panel element 111. Under overpressure the exit direction 108′ for an airflow 108 is substantially perpendicular to panel element 111. The cross section of through hole 107 is larger than the cross section of the duct.

In FIG. 1, in the overpressure situation of open flaps 103 and airflow 108′ the passenger side of the lining panel 101 is assumed to have a higher pressure than the back side 102 of the lining panel 101. Thus, the flaps 103 in FIG. 1 are shown in open position directed to the back side 102 in order to let the airflow 108 easily pass through the through hole 107.

The mounting pads 114, 115 or support elements 114, 115 are provided on panel element 111 in order to support the mounting of the panel element 111 to a fuselage element (not shown in FIG. 1), which has corresponding mounting elements 701, 703. The floor angle 110 is fixed on the cabin floor 112 and on the frame of through hole 107. The frame of through hole 107 may have a groove in order to engage with floor angle 110. In order to reinforce the ribs 109 which maintain the gap 106 between panel element 111 and flaps 103 and/or salient element 104 the U-profile 117 can link the reinforcement profile 105 and/or panel element 111 and the floor angle 110. In this way pressure executed to reinforcement profile 105 and/or panel element 111 is transferred to floor angle 110 and to floor 112.

The foam elements 104, 111, 103, 107, 113 can be manufactured in one shot. Thus at least a part of rapid decompression door 106 can be manufactured in one shot. The flaps 103 can turn around the flexible hinge 113 into different positions. Three examples of positions for the flaps are the open direction, directed to the back side 102 of the panel, the open position directed to the front side 101 of the panel 111 (not shown in FIG. 1), and the closed position (not shown in FIG. 1) where flaps 103 are in contact with frame of through hole 107. In this closed position (not shown in FIG. 1) air flow 108″ would apply.

FIG. 2 shows a detailed view of the rapid decompression door 106 formed by the lining panel 100 according to an exemplary embodiment of the present invention. FIG. 2 shows details of a border 201, an edge 201 or a frame 201 of the through hole 107. The border 201 opposite to hinge 113, 203 is formed as a tongue. On a side of flap 103, which is arranged opposite to hinge 113, 203, flap 103 has a contour 202 that corresponds to tongue 201. This corresponding contour 202 is formed as a groove 202 to be engaged with tongue 201. After being combined or engaged, through hole 107 and flap 103 form a tongue-and-groove joint 201, 202. In this way, the force which moves the flaps 103 from a closed position into an open position can be set. For example, the maximum force, force limit or pressure that can be sustained in a closed position of flaps 103 can be set as to be in the range between 10 hPa to 30 hPa. The force generated by the tension of the elastic material of hinge 113, 203 which presses flaps 103 in a closed position in the direction of tongue 201 of the through hole 107 may be dimensioned such that only a pressure of airflow 108, 108′, 108″ exceeding 30 hPa moves flaps 103 into the open position, as shown in FIG. 1. In that case of overpressure, the airflow 108 is continuing as indicated with arrow 108′ and not in the direction 108″ anymore.

Rib elements 109 are formed in such a way that the tapering salient 104 is formed. Rib elements 109 form sidewalls of a duct through which airflow 108, 108′ can be guided in an overpressure situation. In the opposite case to the case shown in FIG. 2, pressure on the back side 102 is higher than the pressure on the front side 101, the airflow 108, 108′ would be directed in the opposite direction as indicated by arrows 108, 108′, and flap 103 would be turned around hinge 203, 113 into the direction to the front side 101, which in an example is directed into the direction of the inside of a cabin. In an example, front side 101 is linked to a passenger cabin and back side 102 is linked to a cargo compartment. On a lower end and/or an end that is close to the floor 112 and/or on the end where floor angle 110 can be engaged, the rib element 109 comprises the U-profile 117 arranged in a longitudinal direction perpendicular to the floor angle 110. In order to mount floor angle 110 the lower part of salient 104 and/or the lower part of rib element 109 can have a groove.

Realizing hinge 113, 203 as a single part or as a monolithic hinge 113, 203 integrated into salient 104 and/or panel element 111 prevents realising the hinge from a plurality of parts and may reduce audible interferences. The flaps 103 and the through hole 107 form an interlocking shape and the film hinge 113, 203 is integrated into the foamed material. In a normal operation position, after manufacturing, the flaps 103 are brought into a closed position, where groove 202 engages with tongue 201. The pressure limit which defines the threshold value for opening the flaps in an emergency situation can be adjusted by selecting thickness of the material for the flaps 103 and/or by setting up the pressure executed by film hinge 203, 113 in the direction to tongue 201. The three ribs 109 can be built as extruded thermoplastic parts and help maintaining the gap between the through hole 107 and the panel element 111, in particular ribs 109 may help maintaining the gap between panel element 111 and the frame of through hole 107. The number of sub-flaps 103 can also be used to adjust the force for opening the flaps. If a plurality of flaps is used it may be ensured that at least some of the flaps open even if some of the flaps are blocked. The smaller the size of the sub-flaps the smaller the force to open them. The ribs 109 can hold the salient element 104 and can form a frame for through hole 107. The ribs 109 can be used as basis for mounting the reinforcement profile 105. The duct formed by ribs 109, salient element 104, reinforcement profile 105 and/or panel element 111 allows for controlling air circulation through the lining panel 100 in a normal scenario and in an overpressure scenario.

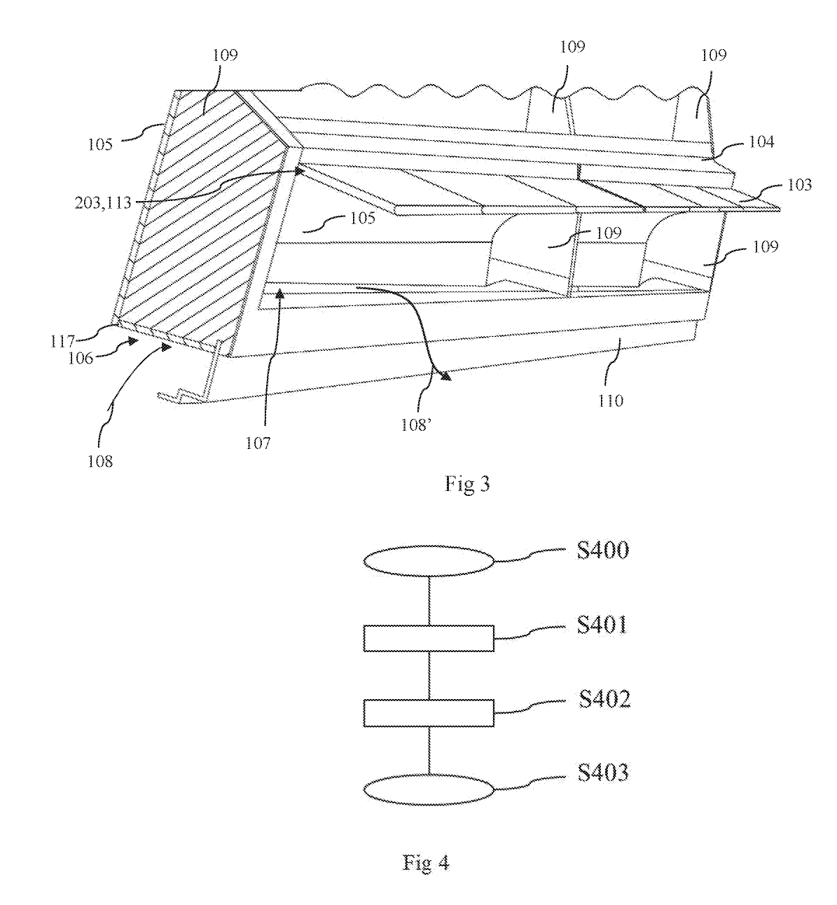

FIG. 3 shows the rapid decompression function 106 or decompression door 106 of FIG. 1 from another viewing angle according to an exemplary embodiment of the present invention. Behind through hole 107 reinforcement profile 105 is visible. This reinforcement profile 105 limits the rapid compression door into the direction of the front side. The air flow 108, 108′ originating from the front side 101 is flowing between floor angle 110, ribs 109, reinforcement profile 105, and through hole 107 to the back side 102 of the lining element. In order to bring the flaps 103 into the open position, the film hinge 203, 113 is used which is formed by pressure forming from the foam part of salient 104. The foremost rib of the ribs 109 is shown in a sectional cut view. In the inside of rib 109 U-profile 117 is available. U-profile 117 comprises the lower part of rib 109 like a bracket. U-profile 117 links reinforcement profile 105 with floor angle 110. U-profile 117 stabilizes rib 109 and may be made of a different material than the rib 109 and/or the panel element 111 or the salient element 104. For example, U-profile 117, reinforcement profile 105 and/or supports 114, 115 are made from the same material. This material may be more robust than the material that is used for panel element 111. However, U-profile 117, reinforcement profile 105 and/or supports 114, 115 are integrated into the lining panel and are integrated at the same time as the lining panel 100 is manufactured. Floor angle 110 is placed into a groove built between U-profile 117 and rib 109 and/or salient 104 in order to allow for easy mounting. The floor angle is releasable by engaging into the groove.

FIG. 4 shows a flow chart of a method for manufacturing the lining element 100 according to an exemplary embodiment of the present invention. The method starts in the starting state S400. In a first step S401, a panel element 111 and/or a salient element 104 having a front side 101 and a back side 102, is provided, e.g. by a foaming process. In step S402, a rectangular through hole 107 is cut into the panel element 111 or in salient element 104. The hinge 113, 203 is formed by thermoplastic pressure and by compressing a part of the foam material of the panel element 111 and/or salient part 104. In this way flap 103 is generated such that the flap 103 is rotatable about the hinge 113, 203. Rotating flap 103 about hinge 113, 203 opens and/or closes rectangular through hole 107. Also the strength for opening the flap 103 is adjusted.

In a particular embodiment, the salient element 104 is mounted on a reinforced profile 105. The hinge 113, 203 is formed such as to be substantially parallel to an edge of flap 103 having the groove and as to be parallel to panel element 111 and/or to reinforcement profile 105. The hinge is substantially perpendicular to ribs 109 when mounted in the lining panel 100. Flap 103 may be used as a valve for balancing overpressure between the front side 101 and back side 102 of the panel element. In order to allow free airflow, the rapid decompression door 106 or a rapid decompression function 106 is formed as a duct and integrated into a salient element of a lining panel 100. The duct can have a predefined size in order to guarantee a predefined cross section for maintaining the unblocked airflow by keeping predefined gap sizes during emergency situations. In order to maintain the cross section of the duct reinforcement element 702 can be integrated into the duct.

In step S403 the manufacturing method is terminated and the lining panel with an integrated rapid decompression door is provided.

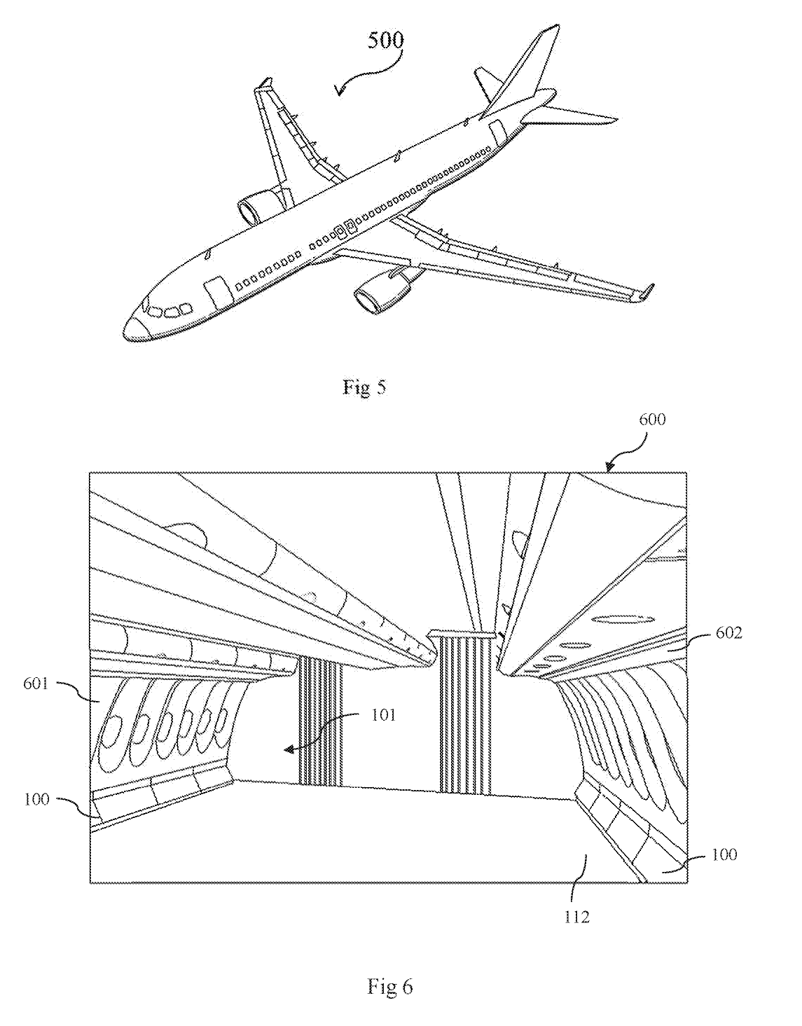

FIG. 5 shows an airplane 500 comprising a fuselage with lining panels 100 (not visible in FIG. 5). The lining panels 100 can be adapted to a grid matching the fuselage elements. The grid may be determined by stringers and ribs of the fuselage of the airplane or aircraft. This standardized sizing of lining panels allows easy mounting of the panels 100 to the interior of a fuselage. Dependent on the type of the airplane, different sizes of fuselage parts can be generated.

FIG. 6 shows a perspective view of the front side 101 of a passenger cabin 600 having lining panels 100 or dado elements 100 arranged in the foot area of window panels 601 close to floor 112, according to an exemplary embodiment of the present invention. The front side 101 may be directed to the interior 101 of the cabin 600. FIG. 6 shows the modular structure of window panels 601 and lining panels 100. The lining panel modules 100 have the same breadth than the window panel modules 601. The lining panels 100 having a size adapted to a fuselage and/or to a fuselage grid are used as fuselage elements. In an example the combination of a window panel 601 with a lining panel 100 forms a fuselage element. Light panels 602 are arranged above window panels 601 in a ceiling area of the cabin 600.

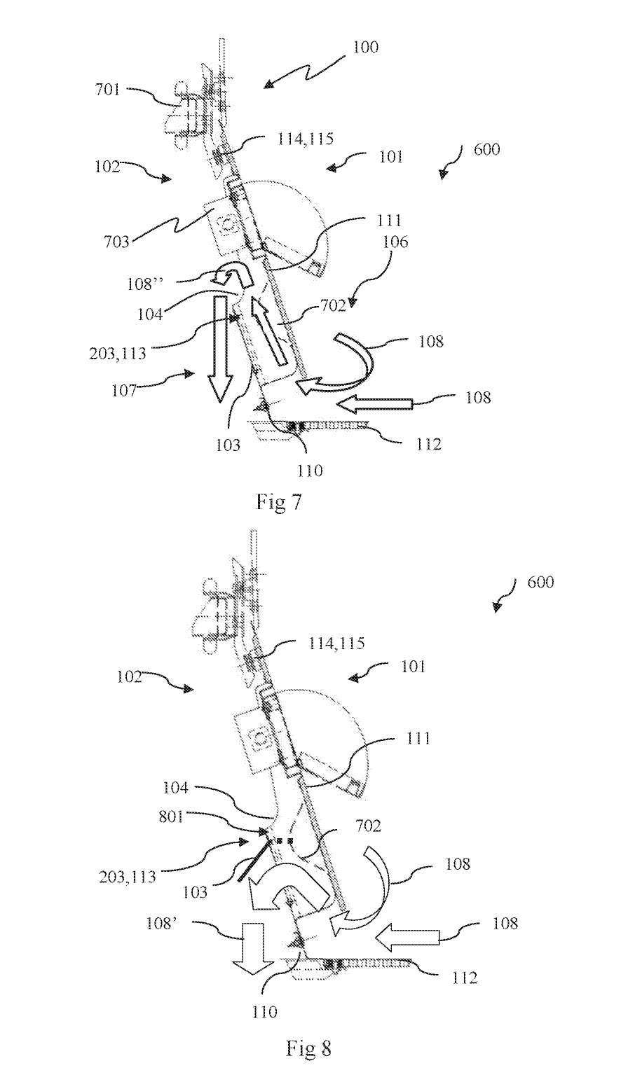

FIG. 7 shows a partial cross sectional view of a lining panel 100 in a normal operation mode according to an exemplary embodiment of the present invention. The panel element 111 is mounted with supports 114, 115 or mounting pads 114, 115 to a fuselage part 701. The fuselage mounting part 701 may be arranged on a rib and/or stringer of a fuselage (not shown in FIG. 7). These mounting parts 701 are arranged in a predefined grid so that lining panels can be made as modules of a corresponding size. For example, the modules are adapted to a certain airplane type, e.g. an Airbus A320 or A380. A further fuselage part is shown as reference number 703. Also this part 703 can be used for mounting panel element 111 to the fuselage. During mounting, supports 114, 115 or mounting pads 114, 115 can be connected to fuselage parts 701 and/or 703 and then rib 109 can be placed on foot angle 110 in such a way that the groove provided in rib 109 and/or in salient element 104 engages with floor angle 110. Under normal conditions air flow, e.g. airflow from air conditioning, flows from the interior 101 of cabin to the exterior 102 of cabin according to air flow 108, 108″ parallel to closed flap 103. The reinforcement structure 702 is used to maintain the diameter of the duct for the air flow 108, 108″ and/or for forming a bottleneck 801 inside the duct. The airflow 108″ leaves the duct behind flaps 103 at the tapering area of salient element 104. This tapering part of salient element 104 in combination with reinforcement structure 702 forms a bottleneck 801. Bottleneck 801 helps to maintain a constant pressure for air conditioning circulation.

The panel element 111 is mounted in an angle selected from a range of about 100°-120° compared to cabin floor 112.

FIG. 8 shows the partial cross sectional view of FIG. 7 in a first rapid decompression operation mode according to an exemplary embodiment of the present invention. By overpressure between interior area 101 of cabin and exterior area 102, flap 103 opens the through hole 107 to an outside area 102 or backside 102 of panel element 111. Pressure to flap 103 is reinforced since bottleneck 801 is formed between structural element 702 and flap hinge 113, 203. Structural tapering element 702 or reinforcement element 702 is extended over the whole breadth of panel element 111. The breadth of panel element 111 in FIGS. 7-9 is directed into the drawing plane. In this over pressure situation of FIG. 8, the air 108 coming from the higher pressure interior area 101 flows through the duct and through the through hole 107 as a large cross sectional flow 108′ into the outer area 102 or cargo area 102. Rapid decompression may be possible by the increased cross section of through hole 107 compared to the cross section of bottleneck 801 in normal operation mode.

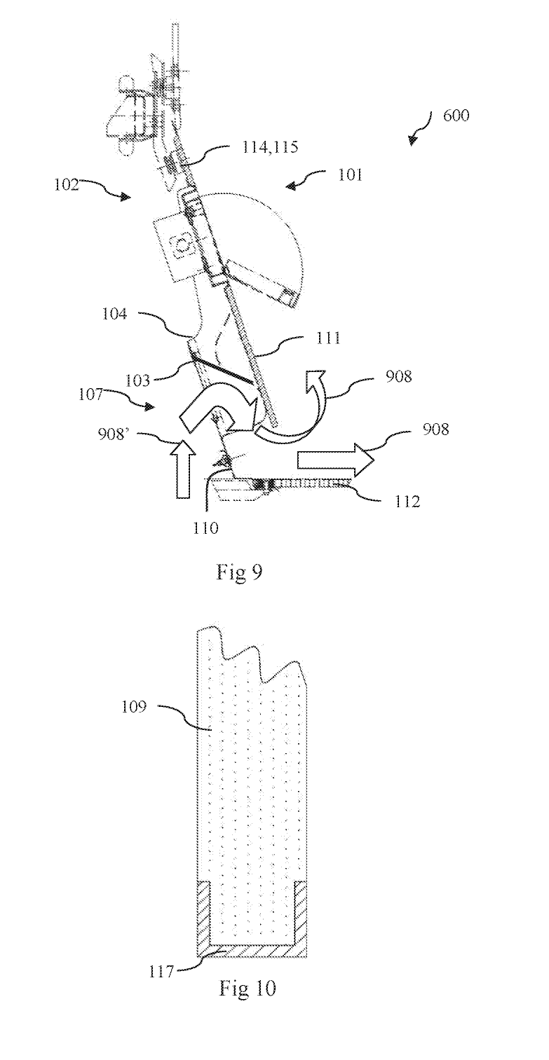

FIG. 9 shows a partial cross sectional view of FIG. 7 in a second rapid decompression operation mode according to an exemplary embodiment of the present invention. In this case over pressure is generated on the backside 102 or in the cargo area 102 and is directed to low pressure region in the interior area 101 of cabin 600. As a consequence of the pressure direction, flap 103 is moved into the direction of panel element 111 and/or to the interior 101 of cabin. The airflow in this case starts in the cargo area 102 as air flow 908′ and is guided through the through hole 107, into the foot area of lining panel 100. The air flow 908 entering the inside 101 of the cabin is guided through a gap between panel element 111 and/or reinforcement profile 105 and floor 112. The cross section of through hole 107 is larger than the cross section of bottleneck 108 allowing for a more rapid pressure equalisation.

FIG. 10 shows a cross sectional view through the lower part of a rib element 109 comprising a U-profile 117 according to an exemplary embodiment of the present invention. The view of FIG. 10 is along the dotted line A of FIG. 1. As can be seen in FIG. 10, U-profile 117 encloses the lower part of rib element 109 like a bracket. Pressure in the drawing plane can be sustained and transferred by the U-profile and enforces the wall section of rib element 109 made of foam. As shown in FIG. 10, the shape of the lower part of rib element 109 is adapted to the shape of U-profile 117. In particular the breadth of rib element 109 is reduced in order to allow a continued and smooth surface of the rib element that may be covered by a protecting layer. The U-profile can be connected to a reinforcement profile and/or to a floor angle (both not shown in FIG. 10). In an example the breadth of rib element 109 is 10 mm. The U-profile 117 has a thickness of 1 mm. Therefore, in the area of U-profile the breadth of rib element 109 is reduce so as to be 8 mm.

It should be noted that the term “comprising” does not exclude other elements or steps and the “a” or “an” does not exclude a plurality. Also elements described in association with different embodiments may be combined. It should also be noted that reference signs in the claims shall not be construed as limiting the scope of the claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A lining panel comprising:
a panel element having a front side and a back side;
a rectangular through hole; and
a flap;
wherein the flap is rotatable about a hinge integrated into the panel element to open and/or close the rectangular through hole.

2. The lining panel of claim 1, further comprising:
a salient;
wherein the salient is arranged on the back side of the panel element, and
wherein the salient comprises the flap.

3. The lining panel according to claim 1, wherein the hinge is formed from the material of a border of the through hole.

4. The lining panel of claim 1, wherein the flap and the through hole form a tongue-and groove joint.

5. The lining panel of claim 1, further comprising a reinforcement layer on the front side.

6. The lining panel of claim 2, further comprising ribs for supporting the salient.

7. The lining panel of claim 1, further comprising a floor angle.

8. A fuselage element for an airplane comprising the lining panel of claim 1.

9. An airplane comprising at least one of the lining panel of claim 1 and a fuselage element comprising the lining panel of claim 1.

10. A method for manufacturing a lining panel of claim 1, the method comprising:
providing a panel element having a front side and a back side;
manufacturing a rectangular through hole and a flap such that the flap is movable about a hinge integrated into the panel element in order to open and/or close the rectangular through hole.
